(19) United States
(12) Patent Application Publication
(10) Pub. No.: US 2026/0167298 A1
(43) Pub. Date: Jun. 18, 2026

(54) Method for Operating a Pedal-Driven Vehicle and a Pedal-Driven Vehicle

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/411,280

(22) Filed: Dec. 7, 2025

(30) Foreign Application Priority Data
Dec. 13, 2024 (DE) 10 2024 211 920.2

(51) Int. Cl. B62M 9/122; B62J 45/20; B62J 45/411; B62M 9/124

(52) U.S. Cl. CPC B62M 9/122; B62J 45/20; B62J 45/411; B62M 9/124

(57) ABSTRACT

A method is disclosed for operating a pedal-driven vehicle including at least one drive for providing a drive torque for propelling the pedal-driven vehicle, a gearshift for providing a variable transmission ratio, and a control unit. The method includes (i) providing a first drive torque by way of the drive, (ii) providing shift information for a planned shift operation, the shift information including a shift direction specification, in particular by way of the gearshift, (iii) determining a second drive torque as a function of the shift information, in particular by the control unit, wherein the second drive torque is less than or equal to the first drive torque, and (iv) controlling the drive such that the drive torque provided by the drive corresponds to the second drive torque, in particular by way of the control unit.

This application claims priority under 35 U.S.C. § 119 to application no. DE 10 2024 211 920.2, filed on Dec. 13, 2024 in Germany, the disclosure of which is incorporated herein by reference in its entirety.

### BACKGROUND

Pedal-driven vehicles, in particular electric bicycles, may be provided with an additional electric drive, which is intended to assist the driver in pedaling and thus to simplify the propulsion of the vehicle for the driver.

If gear changes are performed on the pedal-driven vehicle to alter a transmission ratio in a drive train of the pedal-driven vehicle, a drive torque provided by the electric drive may have negative influences on components of the gear shift used for the gear change.

For example, for derailleur gears, it is necessary to shift the chain to another sprocket during a gear shift. In the course of this shift, the chain can be greatly accelerated by the electric drive due to a temporary lack of sprocket contact and the resulting freedom from the load of the drive. If the contact between the sprocket and the chain is restored subsequently, this will result in a jerky braking of the chain. Such a shift operation may result in damage to the components involved, and further restricts the comfort of use of the pedal-driven vehicle, as such a shift operation is perceived by a driver to be jerky.

### SUMMARY

The present disclosure relates to a method for operating a pedal-driven vehicle, a pedal-driven vehicle, a computer program product, a computer-readable medium, and a data carrier signal. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

The disclosure presented is particularly intended to provide improved operation of a gear shift of a pedal-driven vehicle with respect to improved comfort of use of the pedal-driven vehicle and/or increased service life of the components involved.

According to a first aspect, the present disclosure relates to a method for operating a pedal-driven vehicle, comprising at least one drive for providing drive torque for propelling the pedal-driven vehicle, a gear shift for providing a variable transmission ratio, and a control unit, the method comprising:
providing a first drive torque by the drive,
providing shift information for a planned shift operation, the shift information comprising a shift direction specification, in particular by way of the gear shift,
determining a second drive torque as a function of the shift information, in particular by way of the control unit, wherein the second drive torque is less than or equal to the first drive torque, and
controlling the drive such that the drive torque provided by the drive corresponds to the second drive torque, in particular by the control unit.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method for operating a pedal-driven vehicle is proposed. The pedal-driven vehicle comprises a drive for providing a drive torque for propelling the pedal-driven vehicle. The drive may preferably be configured as an electric motor and/or positioned in a center motor assembly on the pedal-driven vehicle.

Furthermore, the pedal-driven vehicle includes a gear shift for providing a variable transmission ratio, particularly in a powertrain of the pedal-driven vehicle, as well as a control unit. With regard to the present disclosure, the gear shift may preferably be configured as a derailleur gear system. A different configuration of the shifting, e.g. as a hub gear, is also conceivable.

According to the disclosure, it is provided that a first drive torque is provided by the drive, in particular to assist a driver of the pedal-driven vehicle. It is further provided that, in particular by way of the gear shift, shift information is provided for a planned shift operation, in particular at the control unit.

The shift information includes at least one shift direction specification, wherein the shift direction specification is characteristic for whether to shift to a higher gear, i.e. to a higher transmission ratio, or to a lower gear, i.e. a lower transmission ratio, during the shift operation.

If the gear shift is a manual gear shift, the shift direction specification may be generated, for example, depending on the operation of a specific shift lever. In gear shifting, it is common for a shift lever to be provided for upshifting and a further shift lever to be provided for downshifting or for a shift lever to be operated in different directions to upshift or downshift. Thus, the shift direction can be clearly determined as a function of the actuation of a shift lever. For automatic or semi-automated gear shifts, the shift information may be provided directly from the gear shift as information for a future shift operation regarding the shift direction, target gear, and the like at an early stage.

Furthermore, it is provided that, in particular by way of a control unit, a second driving torque is generated as a function of the shift information, in particular at least the shift direction specification. According to the disclosure, the second drive torque is less than or equal to the first drive torque. Furthermore, it is provided that the drive, in particular by way of the control unit, is controlled such that the second drive torque is provided by the drive.

The method according to the disclosure has the advantage that the drive torque provided by the drive is reduced or maintained as a function of the shift direction intended for a planned shift operation. This may prevent mechanical damage to the gear shift during the shift operation while maintaining the drive torque as long and evenly as possible to assist the driver, unless damage to the gear shift is expected.

Preferably, in relation to the present disclosure, it may be preferable for the second drive torque to be smaller or lower when the shift direction specification is characteristic of an increase in the transmission ratio than when the shift direction specification is characteristic of a reduction in the transmission ratio. In other words, it may be provided that the second drive torque is reduced more strongly than the first drive torque when the shift direction indicates that an upshift to a higher gear, i.e., to a higher transmission ratio, occurs than when a downshift to a lower gear, i.e., to a lower transmission ratio, occurs.

In the context of the disclosure, it has been found that an upshift in derailleur gears causes the chain to run freely for a short time, as the chain is shifted from a larger sprocket on the sprocket cassette to a smaller sprocket. This may cause the drive to accelerate the chain rapidly during freewheeling and result in corresponding jerky braking when the chain engages with the smaller sprocket. In contrast, when downshifting with derailleur gears, climbing aids are generally used, which allow for a temporarily reduced but nevertheless continuous power transmission. In this respect it is advantageous that when downshifting, i.e. reducing the transmission ratio, a higher drive torque can be maintained without damaging the gear shift or compromising driver comfort.

In particular, the second drive torque may be provided to correspond to the first drive torque when the shift direction specification is characteristic of a reduction in the transmission ratio. Alternatively, however, it may also be provided that the second drive torque is always less than the first drive torque.

It may be provided in relation to the present disclosure that the method further comprises:
determining a time point for controlling the drive as a function of the shift information, in particular at least the shift direction specification, wherein controlling the drive in particular takes place at the determined time point.

In other words, it can be provided that, in particular by way of the control unit, a time point at which the drive is controlled such that the second drive torque is provided, is determined as a function of the shift information, in particular at least the shift direction specification, and in particular the drive is controlled at the determined time point.

In the context of the disclosure, it has been found that, in derailleur gear systems, the actual movement of the chain can be delayed in relation to the triggering of the shift operation via a shift lever or delayed in relation to the movement of a derailleur. The extent to which this time delay is pronounced will depend on the shift direction. When upshifting, the chain generally moves faster than when downshifting because it switches to a smaller sprocket. When downshifting, the chain has to be moved to a larger sprocket especially when using climbing aids. However, relief of the drive train is only required when the chain is moved, and not when the derailleur is merely moved.

Preferably, it can be provided that the time point for controlling the drive is selected later when the shift direction specification is characteristic of a reduction in the transmission ratio than when the shift direction specification is characteristic of an increase in the transmission ratio. This means that, depending on the switching direction, the drive torque provided by the drive may be maintained unchanged for as long as possible.

The time point for controlling the drive may be determined, for example, as a function of a minimum number of revolutions of the sprocket cassette or sprocket required for the planned shift operation until the chain moves. Such a minimum number of revolutions required may be included, for example, by the shift information or provided by the gear shift for the planned shift operation.

Alternatively, a minimum number of revolutions required may be determined on a model-based basis, in particular by the control unit, as a function of the shift information, in particular a target gear specification and/or shift direction specification. In particular, a functional relationship can be stored, which, as a function of the shift information as an input variable, provides a minimum number of revolutions as an output variable.

Using the minimum number of revolutions required by the sprocket or sprocket cassette to move the chain, and knowing the current rotational speed of the sprocket cassette or sprocket, which can be measured using a speed sensor, for example, it is possible to determine a time during which the chain is not yet moving and therefore no reduction in drive torque is required. After this time has elapsed, preferably the drive torque may be lowered to the second drive torque.

In particular, it is conceivable that the second drive torque, at least when the shift direction specification is characteristic of an increase in the transmission ratio, amounts to a maximum of 80%, preferably a maximum of 70%, particularly preferably a maximum of 60%, or a maximum of 50%, or a maximum of 40% of the first drive torque.

It may further be provided in relation to the present disclosure that the method comprises:
sensing a driver torque provided by a driver of the pedal-driven vehicle to propel the pedal-driven vehicle, in particular by a sensing unit, and
determining the second drive torque such that a sum of the second drive torque and the driver torque is less than or equal to a total torque limit value.

In other words, it may be provided that, when determining the second drive torque, a driver torque provided by a driver of the pedal-driven vehicle is additionally taken into account. The driver torque can, for example, be introduced or introduced via a crank train of the pedal-driven vehicle, in particular into a drive train of the pedal-driven vehicle. In particular, it may be provided that the second drive torque is determined such that a sum of the second drive torque and the driver torque is not greater than a predetermined torque limit.

The torque limit may preferably be selected such that a torque in the drive train corresponding to the torque limit during the planned shift operation is not expected to cause mechanical damage to the gear shift or a restriction on the comfort of use for a driver. By taking the driver torque into account, damage to the gear shift can in particular be prevented even more effectively.

It may be provided in the context of the disclosure that the second drive torque is determined as a torque that is opposite to the driver torque. In other words, it may be provided that the second drive torque is a drive torque that counteracts the driver torque or at least partially compensates for the driver torque. As a result, the drive train, in particular a chain used for torque transmission, can be relieved during the shift operation and mechanical damage to the gear shift can be prevented even more effectively. In particular, high driver torques may be reduced in this way to a level in the drive train that is acceptable during the shift operation. Such a procedure can in particular be used for drive variants without drive freewheel, i.e. drive variants in which the drive torque provided by the drive acts directly on a crank train, via which the driver torque is also introduced.

With regard to the present disclosure, it may also be advantageous if the shift information comprises a target gear specification, wherein the target gear specification is characteristic of a target gear of the planned shift operation and wherein the method further comprises:
determining the second drive torque and/or the time point for controlling the drive in additional dependence on the target gear specification.
A target gear specification is to be understood as a specification of the target gear in which the gear shift is to be actuated. Taking the target gear specification into account has the advantage that not only the shift direction is taken into account when determining the second drive torque, but also the target gear and thus the range of the available gears in which the shift is currently taking place.

A target gear specification can be provided simply and reliably, in particular in the case of automatic or semi-automated shifts, since there is always knowledge of the current gear in the gear shift and unambiguous shift operations are associated with the user interfaces. Even with manual shifts, the target gear specification can be determined from the current gear as well as knowledge of the shift direction, which can be derived from the respective actuation of a specific user interface, in particular a shift lever.

It can preferably be provided that with an increasing transmission ratio of the target gear characterized by the target gear specification, the second drive torque is selected to be lower, in particular increasingly lower. In other words, it may be provided that the second drive torque is reduced more strongly relative to the first drive torque, the higher the target gear characterized by the target gear specification. This procedure has proven advantageous in the context of the present disclosure with regard to the prevention of mechanical damage to the gear shift.

Additionally or alternatively, it can be provided that, with an increasing transmission ratio of the target gear characterized by the target gear specification, the time for controlling the drive is selected earlier, in particular increasingly earlier. In other words, it may be provided that the time for controlling the drive is selected earlier, the higher the target gear characterized by the target gear specification. This procedure has proven advantageous in the context of the present disclosure with regard to the prevention of mechanical damage to the gear shift.

It may be advantageously provided that the method further comprises:
controlling the drive such that the drive torque provided by the drive corresponds to the first drive torque again, in particular by the control unit.

In other words, it may be provided that the drive is controlled after the second torque has been provided, in particular after a predetermined amount of time, to provide the first drive torque again. This control of the drive may occur in particular after a predetermined period of time or at a predetermined time after the drive torque has been reduced to the second drive torque. This allows the original driver assistance provided by the drive to be restored.

In particular, it may be provided that the shift information further comprises a start time and/or a planned duration for carrying out the planned shift operation. In this context, it may be preferable to provide that the predetermined period of time after which the drive is controlled to again provide the first drive torque again, or a predetermined time point at which the drive is controlled to provide the first drive torque, is determined as a function of the start time and/or the planned duration to perform the planned shift operation.

The planned duration of a shift operation can in particular be determined as a function of the shift direction specification and/or the target gear specification. In particular, with derailleur gears, upshifting is expected to take a comparatively short time, as the chain is shifted from a larger sprocket to a smaller sprocket on the sprocket cassette. When downshifting, however, a longer duration is to be expected, as the shift operation is only executed when a climbing aid has reached the correct circumferential position, which can take up to one revolution of the sprocket cassette. Also, the presence or number of climbing aids may vary depending on which gear is being shifted to which target gear.

In particular, a maximum number of revolutions of the sprocket cassette or sprocket required for complete execution of the shifting operation may be specified for a shift operation. On this basis, knowing the current rotational speed of the sprocket cassette or the sprocket, which can be sensed by a speed sensor, for example, it is possible to determine a time after which the shift operation is safely completed. This time may be used as the planned duration of a shift operation after which the drive torque may be increased again. Such a maximum number of revolutions required may be included, for example, by the shift information or provided by the gear shift for the planned shift operation.

Alternatively, a maximum number of revolutions required may be determined on a model-based basis, in particular by the control unit, as a function of the shift information, in particular a target gear specification and/or shift direction specification. In particular, a functional relationship can be stored, which, as a function of the shift information as an input variable, provides a maximum number of revolutions as an output variable.

It may further be provided that the method comprises sensing a speed of a sprocket cassette of the pedal-driven vehicle, in particular by a sensing unit or speed sensor.

According to a second aspect, the present disclosure relates to a pedal-driven vehicle comprising at least one drive for providing drive torque for propelling the pedal-driven vehicle, a gear shift for providing a variable transmission ratio, and a control unit. The pedal-driven vehicle is preferably configured to be operated according to a method according to the disclosure. Preferably, the pedal-driven vehicle may be configured as a bicycle, preferably an electric cycle or pedelec. With respect to a pedal-driven vehicle, the same advantages result as described in relation to a method according to the disclosure. Preferably, the pedal-driven vehicle may comprise two wheels, in particular a front wheel and a rear wheel.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank train of the vehicle. In this respect, a high transmission ratio or high gear characterizes a comparatively high number of revolutions of the drive gear per revolution of the crank train. In contrast, a low transmission ratio or low gear characterizes a comparatively low number of revolutions of the drive gear per revolution of the crank train. In particular, a driver of the pedal-driven vehicle may introduce a driver torque to propel the vehicle, in particular via crank-drive pedals, via the crank train.

In particular, a rear wheel of the pedal-driven vehicle may serve as a drive wheel that is driveable via a crank train. An effective connection between the drive wheel and the crank train may be formed via the gear shift, wherein the gear shift can provide a variable transmission ratio between the drive wheel and the crank mechanism.

In the present case, the gear shift may be configured as a derailleur gear system or a hub gear. In particular, the present disclosure has proven to be extremely advantageous with respect to a derailleur gear system.

Additionally or alternatively, it may be provided that the gear shift is configured as an automatic or at least partially automated gear shift. In particular, it can be provided that shift operations of the gear shift do not have to be triggered manually by a driver of the vehicle, but instead occur automatically based on one or more travel parameters. A travel parameter may be, for example, a speed of the pedal-driven vehicle, a pedaling frequency of a driver of the pedal-driven vehicle, a driver torque introduced by a driver of the pedal-driven vehicle to propel the vehicle, or a power provided by a driver of the pedal-driven vehicle to propel the vehicle.

It may be provided in the context of the disclosure that at least one sensing unit comprises at least one torque sensor for sensing a driver torque. For example, the driver torque may be sensed on a crank train of the pedal-driven vehicle via which the driver torque may be introduced.

It may be provided in the context of the disclosure that at least one sensing unit comprises at least one speed sensor for sensing a speed of a sprocket cassette of the pedal-driven vehicle.

It may be provided in the context of the disclosure that at least one gear shift and/or control unit and/or sensing unit comprises data processing device. The data processing device may comprise at least one processor and/or working memory and/or non-volatile data store.

At least one control unit may be brought into communication and/or signal communication with a gear shift and/or sensing unit and/or at least one drive, at least temporarily. Thus, data and/or control or regulating signals between the respective units or components may be exchanged.

According to a third aspect, the present disclosure relates to a computer program product comprising instructions that cause a pedal-driven vehicle according to the disclosure to perform a method according to the disclosure, in particular a method according to a first aspect of the disclosure. With respect to a computer program product according to the disclosure, the same advantages result in that they have already been described in relation to a method according to the disclosure and/or a pedal-driven vehicle according to the disclosure.

According to a fourth aspect, the present disclosure relates to a computer-readable medium, in particular a storage medium, wherein a computer program product according to the disclosure is stored on the computer-readable medium. With respect to a computer-readable medium according to the disclosure, the same advantages result in that they have already been described in relation to a method according to the disclosure and/or a pedal-driven vehicle according to the disclosure and/or a computer program product according to the disclosure.

According to a fifth aspect, the present disclosure relates to a data carrier signal transmitting a computer program product according to the present disclosure. With respect to a data carrier signal according to the disclosure, the same advantages result in that they have already been described in relation to a method according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a view of a method, and

FIG. 2 is a view of a pedal-driven vehicle.

### DETAILED DESCRIPTION

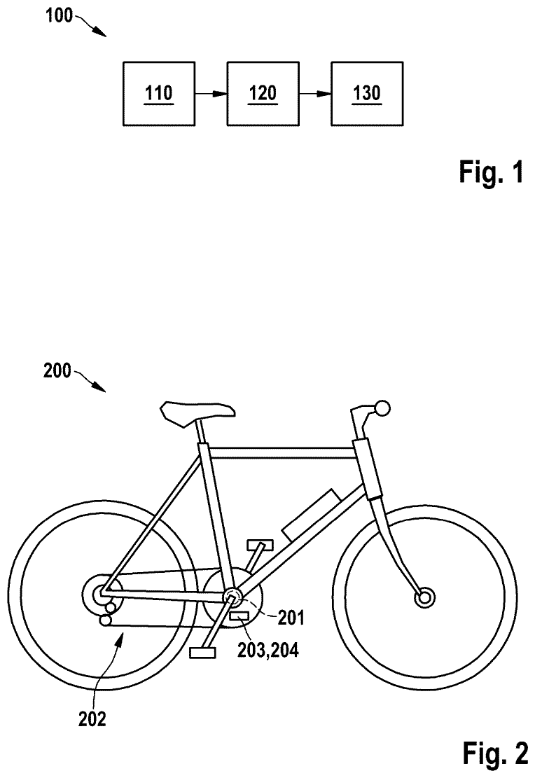

FIG. 1 illustrates a schematic view of a method 100 for operating a pedal-driven vehicle 200, comprising at least one drive 201 for providing a drive torque for propelling the pedal-driven vehicle 200, a gear shift 202 for providing a variable transmission ratio, and a control unit 203, the method 100 comprising:
providing 110 a first drive torque by the drive 201,
providing 110 shift information for a planned shifting operation, the shift information comprising a shift direction specification, in particular by the gearshift 202,
determining 120 a second drive torque as a function of the shift information, in particular by the control unit 203, wherein the second drive torque is less than or equal to the first drive torque, and
controlling 130 the drive 201 such that the drive torque provided by the drive 201 corresponds to the second drive torque, in particular by the control unit 203.

Furthermore, FIG. 2 illustrates a schematic view of a pedal-driven vehicle 200, comprising at least one drive 201 for providing a drive torque for propelling the pedal-driven vehicle 200, a gear shift 202 for providing a variable transmission ratio, as well as a control unit 203 and a sensing unit 204. The sensing unit 204 and the control unit 203 may optionally be integrated into a common unit (as shown here). Preferably, the pedal-driven vehicle 200 is configured to operate according to a method 100 shown in FIG. 1.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a pedal-driven vehicle including at least one drive configured to provide a drive torque for propelling the pedal-driven vehicle, a gearshift configured to provide a variable transmission ratio, and a control unit, the method comprising:
providing a first drive torque by way of the drive;
providing shift information for a planned shift operation, the shift information including a shift direction specification by way of the gearshift;
determining a second drive torque as a function of the shift information by way of the control unit, wherein the second drive torque is less than or equal to the first drive torque, and
controlling the drive such that the drive torque provided by the drive corresponds to the second drive torque by way of the control unit.

2. The method according to claim 1, wherein:
the second drive torque is less when the shift direction specification is characteristic of an increase in the transmission ratio than when the shift direction specification is characteristic of a reduction in the transmission ratio.

3. The method according to claim 1, further comprising:
determining a time point for controlling the drive as a function of the shift information and controlling, wherein controlling the drive occurs at the determined time point.

4. The method according to claim 3, wherein:
the time point for controlling the drive is selected later when the shift direction specification is characteristic of a reduction in the transmission ratio than when the shift direction specification is characteristic of an increase in the transmission ratio.

5. The method according to claim 1, further comprising:
sensing a driver torque provided by a driver of the pedal-driven vehicle to propel the pedal-driven vehicle by way of a sensing unit, and
determining the second drive torque such that a sum of the second drive torque and the driver torque is less than or equal to a total torque limit value.

6. The method according to claim 1, wherein the second drive torque is determined as a torque that is opposite to the driver torque.

7. The method according to claim 1, wherein the shift information includes a target gear specification, wherein the target gear specification is characteristic of a target gear of the planned shift operation, and wherein the method further comprises:
determining the second drive torque and/or the time point for controlling the drive in additional dependence on the target gear specification.

8. The method according to claim 7, wherein:
with an increasing transmission ratio of the target gear characterized by the target gear specification, the second drive torque is selected to be increasingly lower.

9. The method according to claim 1, further comprising:
controlling the drive such that the drive torque provided by the drive corresponds to the first drive torque again by way of the control unit.

10. A pedal-driven vehicle, comprising:
at least one drive configured to provide a drive torque for propelling the pedal-driven vehicle;
a shift gear configured to provide a variable transmission ratio; and
a control unit,
wherein the pedal-driven vehicle is configured to operate according to the method of claim 1.

11. A computer program product comprising instructions that cause a pedal-driven vehicle to perform the method according to claim 1.

12. A computer-readable medium on which the computer program product according to claim 11 is stored.

13. A data carrier signal transmitting the computer program product according to claim 11.
